(19) United States
(12) Patent Application Publication
(10) Pub. No.: US 2004/0261430 A1
(43) Pub. Date: Dec. 30, 2004

(54) Refrigerating appliance

(75) Inventors: Anton Stempfle, Giengen (DE); Christian Mayershofer, Grundremmingen (DE); Rainer Brachert, Gundelfingen (DE); Andreas Reiter, Morslingen (DE); Rudolf Schmidt, Giengen (DE)

Correspondence Address: JOHN T. WINBURN, 100 BOSCH BOULEVARD, NEW BERN, NC, 28562, US

(73) Assignee: BSH Bosch und Siemens Hausgerate GmbH, Munich (DE)

(21) Appl. No.: 10/788,569

(22) Filed: Feb. 27, 2004

(30) Foreign Application Priority Data
Sep. 4, 2001 (DE) 10143240.2
Aug. 30, 2002 (WO) PCT/EP02/09697

(51) Int. Cl. F25B 49/00; G01K 13/00; F25D 15/00; F25D 23/12

(52) U.S. Cl. 62/125; 62/129

(57) ABSTRACT

A refrigerating appliance with an inner chamber enclosed by a heat-insulating housing and a plurality of electrical or electromechanical components. The components including a cooling circuit for cooling the inner chamber and at least one temperature sensor. A control unit for controlling the cooperation of the components, which control unit has a test operating mode for checking the operative ness of at least some of the components.

Refrigerating appliances, in particular for commercial applications, can be constructed from a plurality of electrical or electromechanical functional components, which cooperate in complex fashion, so that when a malfunction of the appliance is observed, often it is difficult to judge which of the diverse components is the cause of the observed malfunction. To identify a malfunctioning component quickly and correctly a high level of training of customer service representatives is required, which is expensive to maintain. In particular, in the case of a model change knowledge and experience, which has been collected by the customer service representatives on previous models, cannot be seamlessly transferred to the new models, because as a rule the experience of customer services representatives has flows, via the most significant malfunctions, into the development of new models, so that even these malfunctions no longer occur, or in any case do so to a lesser degree. The more complex the appliance, the more multi-faceted the set of replacement parts, which a customer services representative must carry, to be able to repair a customer appliance with the greatest probable success. It is therefore preferable, when a malfunction of an installed appliance occurs, to be able to assess the cause of the malfunction as reliably as possible, even before a customer service representative sets out to visit the customer, so that the latter can take along those replacement parts most needed on-site.

The object of the invention is to provide a refrigerating appliance, which in the event of a malfunction enables possible malfunction causes to be localised, without the necessity of an on-site visit by a customer service employee, or before such a visit is made.

A refrigerating appliance having the features of claim 1 solves this task. Since modern refrigerating appliances frequently use a microprocessor as control unit, it is possible without an appreciable rise in manufacturing costs, in particular in the form of a sub-program for such a microprocessor to implement a test operating mode in addition to the operating mode for normal refrigeration, in which the control unit is capable of carrying out checks on the operativeness of at least some of the components of the refrigerating appliance.

A basic component for any checking of operativeness of a refrigerating appliance is at least a temperature sensor, which must be provided to regulate the internal temperature of the refrigerating appliance. The control unit is preferably set up to detect a malfunction of such a temperature sensor, in particular by short circuit or break in one of its lines.

Only when the check on operativeness of the temperature sensor has not returned any indication of a malfunction, is it appropriate to perform checks on the operativeness of other components, such as for example the coolant circuit, for the assessment of which measuring the inner chamber temperature is required.

To check its operativeness the control unit effectively outputs a command for operating the coolant circuit, and compares a change in temperature detected while the command is being validated with a set value. If this temperature change is less than the set value, then can a malfunction of the coolant circuit can be assumed, and a check can be run on the individual components of the coolant circuit.

It is known per se to equip a refrigerating appliance with a display unit, such as a seven-segment display, to show the inner chamber temperature. This type of display unit can also be controlled according to the present invention preferably by the control unit to display the results of operativeness checks. A user of the refrigerating appliance can thus read off the results and convey them e.g. by telephone to a customer service representative, who can estimate possible cause of the malfunction on the basis of this data, and can determine which measures and possibly replacement parts are required to correct the malfunction.

Because operating the refrigerating appliance in test operating mode can lead to fluctuations in the inner chamber temperature, it is preferably to ensure that this is not activated in error. This can e.g. be ensured in a refrigerating appliance, which has a plurality of keys for adjusting operating parameters, by the test-operating mode being adjustable only by actuating a combination of these keys.

Further features and advantages of the invention will emerge from the following description of an embodiment of the invention with reference to the attached figures, in which:

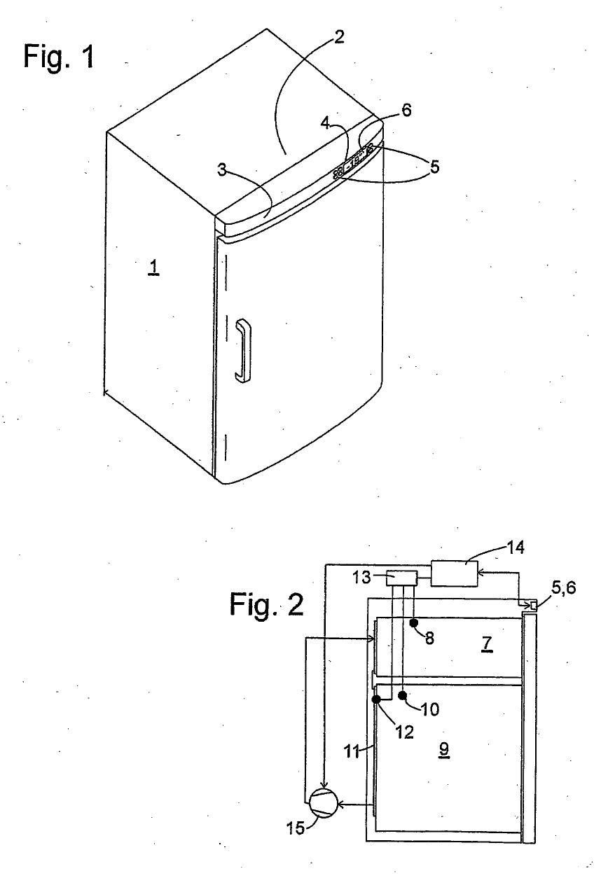

FIG. 1 shows a perspective view of a refrigerating appliance according to the present invention;

FIG. 2 shows a schematic block diagram of the refrigerating appliance, and

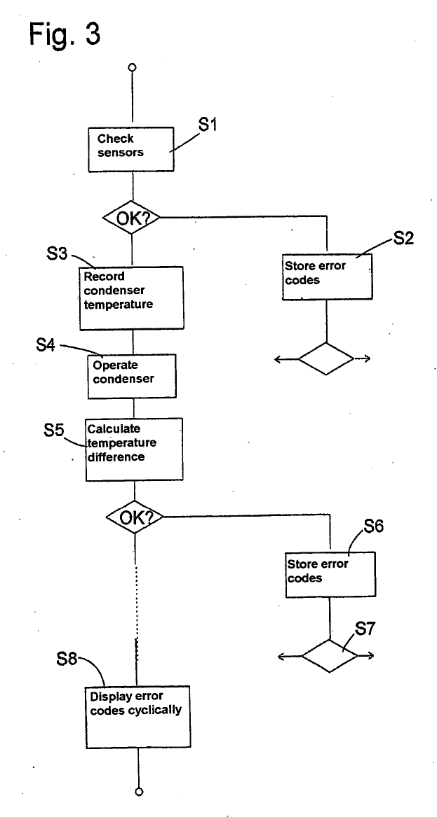

FIG. 3 shows a flow diagram of a working method of the control unit of the refrigerating appliance in test operating mode.

Above the door 2 the housing 1 of the refrigerating appliance has a front-mounted hollow screen 3, housing electronic circuits for controlling the operation of the refrigerating appliance. Located on the front side of the screen 3 is a control panel 4 with a plurality of keys 5 for setting operating parameters, such as the set temperatures of a cooler compartment and a freezer compartment inside the housing 1 etc.

The keys 5 are arranged on both sides of an LED display 6, which displays e.g. the temperature of a compartment selected by the user by pressing a key 5.

FIG. 2 diagrammatically illustrates a few functional components of the refrigerating appliance, including a temperature sensor 8 arranged in the freezer compartment 7, a temperature sensor 10 arranged in the cooler compartment 9, as well as a temperature sensor 12 arranged in contact with an evaporator 11 of the cooler compartment 9. The temperature sensors 8, 10, 12 are connected to a transmitter circuit 13, which delivers measured temperature values in digitalised form supplied by the sensors to a control unit 14. The transmitter circuit 13 and control unit 14 can be part of the circuits in the hollow screen 3.

When the refrigerating appliance is in normal operating mode the control unit 14, by means of the temperatures measured, controls the operation of a condenser 15, which supplies the evaporator 11 and an evaporator 16 of the freezer compartment with coolant, receives commands from a user by way of the keys 5, and controls the LED display 6 to display an operating parameter specified by a user.

In addition the control unit 14 has a test-operating mode, which can be activated by a user by simultaneous or successive pressing of a plurality of keys 5. The keys 5 to be actuated in combination are located on both sides of the LED display 6, in order to minimise the probability of unintentional pressing.

The control unit includes a (not illustrated) program memory, in which are stored program steps to be followed for a series of checking operations and the sequence in which these are to be executed. As long as execution of the checking steps does not return any indication of a malfunction, they are processed in sequence. Whenever a program operation indicates a malfunction, then the result of this is that checking steps, which are to be executed at a later point in the standard programming, are made obsolete, because components required to execute them are defective. For such a case alternative checking steps can be stored, or the checking operations are interrupted.

FIG. 3 diagrammatically illustrates an example for operations carried out in the test operating mode. A first operation S1 is checking the temperature sensors 10, 12, 14. The temperature sensors are thermoelements, whereof the temperature-dependent initial voltage is converted into a digital temperature value, with normal operation of the transmitter circuit 13. To check the sensors the control unit switches the transmitter circuit 13 to an operating mode, in which it detects the resistance of the temperature sensors. If the latter is beyond a lower or upper limit value, then a short circuit or interruption of a line of the temperature sensor is chosen, and a corresponding error code is stored in step S2 by the control unit. Should one of the temperature sensors be defective, checking steps, which presuppose the operativeness of this sensor, can no longer be executed. Complete inspection of the operativeness of the coolant circuit can no longer occur; but an estimation of the operativeness of the condenser 15 is made possible through measuring its electrical power consumption.

When the temperature sensors, in particular temperature sensor 12, are functional, the control unit in step S3 records the temperature of the evaporator 11 and in step S4 outputs a command for operating the condenser 15. If this has been in operation for a preset time interval of e.g. 10 minutes uninterrupted, then it should result in a drop in temperature of the evaporator 11 by e.g. at least 4° C. On completion of 10 minutes the control unit in step S5 calculates the difference between the recorded and the current evaporator temperature, and compares this to the limit value of 4 C. If the difference exceeds the limit value, there is no indication of a malfunction of the coolant circuit, and the test program is continued according to the preset sequence of checking steps. If the temperature difference is not reached, the control unit in step S6 then stores the corresponding error code, checks in step S7 whether there are additional checking operations, which can be carried out under these circumstances, and jumps ahead if necessary.

If a check determines that all checking operations are processed or the checking operations are interrupted, because no more can be appropriately carried out due to a recognised malfunction, the procedure advances to step S8, where the control unit triggers the LED display 6 to display the stored error codes cyclically alternating. A user can read these error codes in sequence and advise customer services e.g. by telephone, so that prior to an on-site visit the possible causes of the malfunction can be localised, and there is a greater probability that the malfunction can be eliminated by consultation with a customer services representative.

1-7. (canceled)

8. a refrigerating appliance, comprising:
an inner chamber enclosed by a heat-insulating housing;
a plurality of electrical or electromechanical components coupled to said inner chamber;
said components including a coolant circuit for cooling said inner chamber;
said components including at least one temperature sensor;
a control unit for controlling the operation of said components, said control unit including a test operating mode for checking the operativeness of at least some of said components; and
said control unit checking the operativeness of said coolant circuit if first checking the operativeness of said temperature sensor does not provide an indication of a malfunction of said temperature sensor.

9. The refrigerating appliance according to claim 8, including said control unit set up to detect a malfunction of said temperature sensor, said malfunction being one of a short circuit or an electrical line break.

10. The refrigerating appliance according to claim 8, including said control unit checking the operativeness of said coolant circuit by outputting a command for operating said coolant circuit for a predetermined temperature change and comparing a sensed temperature change detected while validating said command with a set value change in temperature.

11. The refrigerating appliance according to claim 10, including said coolant circuit including an evaporator and said temperature sensor is arranged in contact with said evaporator.

12. The refrigerating appliance according to claim 11, including a display unit which can be activated by said control unit for displaying results of said operativeness tests.

13. The refrigerating appliance according to claim 12, including a plurality of operating keys for setting operating parameters and said test operating mode can be adjusted by actuating a combination of said keys.

14. The solenoid valve according to claim 13, including said combination of operating keys for setting said test operating mode are located on opposite sides of said display.

15. The refrigerating appliance according to claim 8, including a plurality of operating keys for setting operating parameters and said test operating mode can be adjusted by actuating a combination of said keys.
